(19) United States
(12) Patent Application Publication
(10) Pub. No.: US 2019/0377586 A1
(43) Pub. Date: Dec. 12, 2019

(54) GENERATING CUSTOMIZED USER INTERFACE LAYOUT(S) OF GRAPHICAL ITEM(S)

(71) Applicant: MICROSOFT TECHNOLOGY LICENSING, LLC, Redmond, WA (US)

(72) Inventors: Jason Thomas FAULKNER, Seattle, WA (US); Sonu ARORA, Kirkland, WA (US); Santhosh Kumar MISRO, Issaquah, WA (US); Joshua GEORGE, Redmond, WA (US)

(21) Appl. No.: 16/003,757

(22) Filed: Jun. 8, 2018

(51) Int. Cl. G06F 9/451; G06T 11/60; G06F 3/0482

(52) U.S. Cl. CPC G06F 9/451; G06T 2200/24; G06F 3/0482; G06T 11/60

(57) ABSTRACT

The disclosed system generates a customized layout based on an analysis of characteristics of graphical items to be displayed. The graphical items can include user interface (UI) control elements (e.g., buttons, a menu, menu options, etc.) streamed content (e.g., video feeds), file content of different types (e.g., text, images, etc.), or other items that can be displayed to a user. The system can analyze preferred characteristics that are based on previously selected graphical items and previously used layouts. The system can then configure a customized layout that includes one or more display areas. Each display area contains at least one graphical item. The preferred characteristics can be used to automatically select graphical items that have a characteristic that correlates with a characteristic of a previously selected graphical item. The customized layout can then be presented to a user.

### BACKGROUND

In some existing systems, users can modify graphical interface layouts of computer programs. For example, in a word processing program or a video conferencing application, a user may arrange icons, buttons, content display areas, or other graphical items to improve computer interactions and make computer interactions more efficient. Although some existing applications provide user interface (UI) customization features, such features are limited in many ways. For example, some graphical items, such as buttons and document display areas, of a word processing application can only be moved to certain locations. In another example, display areas for video and document content in communication applications may be limited to a number of predetermined layouts.

In addition to the above-described limitations, existing programs also require users to manually configure UI layouts. In some scenarios, this can be a cumbersome process that does not always lead to an optimal layout for particular workflow. In addition, the user typically spends a considerable amount of time (i) searching through available graphical items to find the graphical items that are relevant to a particular purpose, and/or (ii) manually generating a desired layout of the selected graphical items. This can lead to extensive and/or unnecessary consumption of computer resources. In addition, having a less than optimal UI layout can lead to other user interaction inefficiencies during operation of the application.

### SUMMARY

The techniques described herein enable a computing device to generate customized user interface (UI) layouts based on an analysis of characteristics of graphical items the user is interacting with and historical user activity. In one illustrative example, a variety of available graphical items can be analyzed by a system to identify characteristics that are relevant to a particular purpose. The graphical items can include control buttons, menu items, streamed content (e.g., video feeds), file content, or other items that can be displayed to a user. The system can also analyze preferred characteristics that are based on previously selected graphical items and previously used layouts. The system can then configure at least one customized UI layout comprising one or more display areas having at least one selected graphical item. The preferred characteristics can be used to automatically select graphical items that have a characteristic that correlates with a characteristic of a previously selected graphical item. The customized UI layout can then be presented to a user.

The present techniques offer a number of improvements over existing systems for a number of reasons. For instance, the system described herein can provide contextually-relevant UI layouts while minimizing or eliminating the need for manual input that may be required for a customization process. The user does not have to spend a considerable amount of time and computing resources that are usually required for the traditional, labor-intensive process of manually generating a layout for a particular purpose. In addition, the present techniques provide improvements in terms of the diversity of the layouts, providing more flexibility with regard to: the number of graphical items that are displayed in a layout, the size of graphical items that are displayed in the layout, and positions of the graphical items that are displayed in the layout with respect to one another.

In various examples, a correlation or a correspondence between characteristics of a current graphical item available for display and the preferred characteristics revealed via an analysis of a user history of previous selection and/or previous layouts can include a characteristic match or a characteristic similarity (e.g., a same or similar function to be executed, a same or similar type of data, a same or similar identified user in an image or a video feed, a same or similar type of event captured in an image or a video feed, etc.). Using the user's own history, the system can provide contextually-relevant UI layouts while minimizing or eliminating the need for manual input that may be required for a customization layout process. The techniques disclosed herein improve user interaction with a computer along with providing improvements with respect to processing resources, network resources, and memory resources. For instance, with the introduction of the techniques disclosed herein, a user's need to interact with a computer to design and generate layouts is mitigated. Such an improved user interaction can lead to the reduction of inadvertent inputs and redundant inputs, and based on which other efficiencies, including production efficiencies, network efficiencies, processing efficiencies, memory efficiencies, and network usage efficiencies, can be improved.

In some implementations, a system may include means to analyze a plurality of graphical items to identify characteristics of each graphical item and means to access information that includes preferred characteristics of a user. The system may also include means to configure at least one layout, wherein an individual layout comprises a plurality of display areas and an individual display area contains a graphical item of the plurality of graphical items. The graphical item may be selected based on a correspondence (e.g., a match, a similarity, etc.) between the characteristics of the graphical item and the preferred characteristics. Furthermore, the system may include means to display the at least one layout within a graphical user interface.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 provides a diagram that illustrates an example of how previous user selection of graphical items and/or previous user configuration of layouts of the selected graphical items can be used to automatically generate one or more layouts.

FIG. 2 provides a diagram that illustrates an example that shows how previously configured layouts of graphical items (e.g., user interface control elements and/or portions of text and images) can be used to generate a customized layout using a current set of graphical items.

FIG. 3 provides a diagram that illustrates another example that shows how previously configured layouts of graphical items (e.g., video feeds) can be used to generate a customized layout using a current set of graphical items.

FIG. 4 illustrates a diagram that shows example components of a device configured to select graphical item(s) and generate one or more layouts for a user.

FIG. 5 is a diagram of an example flowchart that illustrates operations directed to automatically selecting and/or configuring one or more layout(s) based on preferred characteristics of a user.

FIG. 6 is a diagram illustrating an example environment in which a system can operate to populate a staging area and/or a sequential timeline of a graphical user interface with candidate layouts.

FIG. 7 is a diagram of an example flowchart that illustrates operations directed to populating a staging area with candidate layouts in order to enable identification and selection of a next layout to be shared and displayed in a communication session.

FIG. 8 illustrates an example graphical user interface configured to display a view into a communication session for a host or a producer.

FIG. 9A illustrates another example graphical user interface configured to display a view into a communication session for a host or a producer.

FIG. 9B illustrates yet another example graphical user interface configured to display a view into a communication session for a host or a producer.

FIG. 10 is a diagram of an example flowchart that illustrates operations directed to enabling a host or a producer to add candidate layouts to a sequential timeline.

FIG. 11 illustrates an example graphical user interface that illustrates how a candidate layout can be added to a sequential timeline displayed in a view provided to a host or a producer of a communication session.

### DETAILED DESCRIPTION

The system described herein generates a customized layout based on an analysis of characteristics of graphical items to be displayed. The graphical items can include user interface (UI) control elements (e.g., buttons, a menu, menu options, etc.) streamed content (e.g., video feeds), file content of different types (e.g., text, images, etc.), or other items that can be displayed to a user. The system can analyze preferred characteristics that are based on previously selected graphical items and previously used layouts. The system can then configure at least one customized layout that includes one or more display areas. Each display area contains at least one graphical item. The preferred characteristics can be used to automatically select graphical items that have a characteristic that correlates with a characteristic of a previously selected graphical item. The customized layout can then be presented to a user.

In various examples, graphical items are selected an arranged based on a correspondence between characteristics of a current set of graphical items available to be displayed and the preferred characteristics revealed via an analysis of a user history. The aforementioned correspondence may include a characteristic match or a characteristic similarity (e.g., a same or similar function to be executed, a same or similar type of data, a same or similar identified user in an image or a video feed, a same or similar type of event or activity captured in an image or a video feed, etc.).

In various implementations, the graphical items can be video feeds. The techniques described herein can assist a person tasked with configuring a layout of video feeds for a communication session (e.g., a producer of the communication session, a host of the communication session, etc.). In various implementations, the system is configured to populate a staging area with candidate layouts. The staging area comprises a portion of a graphical user interface that is presented to the person tasked with configuring the layout of video feeds for the communication session. The staging area allows the person to preview different candidate layouts during the communication session as activity that captures the context of the communication session is detected.

Using the staging area, the person can identify and select a candidate layout that best captures the context of the communication session and efficiently transition the selected candidate layout into a presentation area of the graphical user interface so it can be shared with the participants of the communication session (e.g., a current layout being broadcast live to the participants is replaced with a new layout). Consequently, the staging area can be used as a tool to help automate the process of configuring a layout of video feeds for a communication session, thereby conserving computing resources (e.g., processing resources, memory resources, and networking resources).

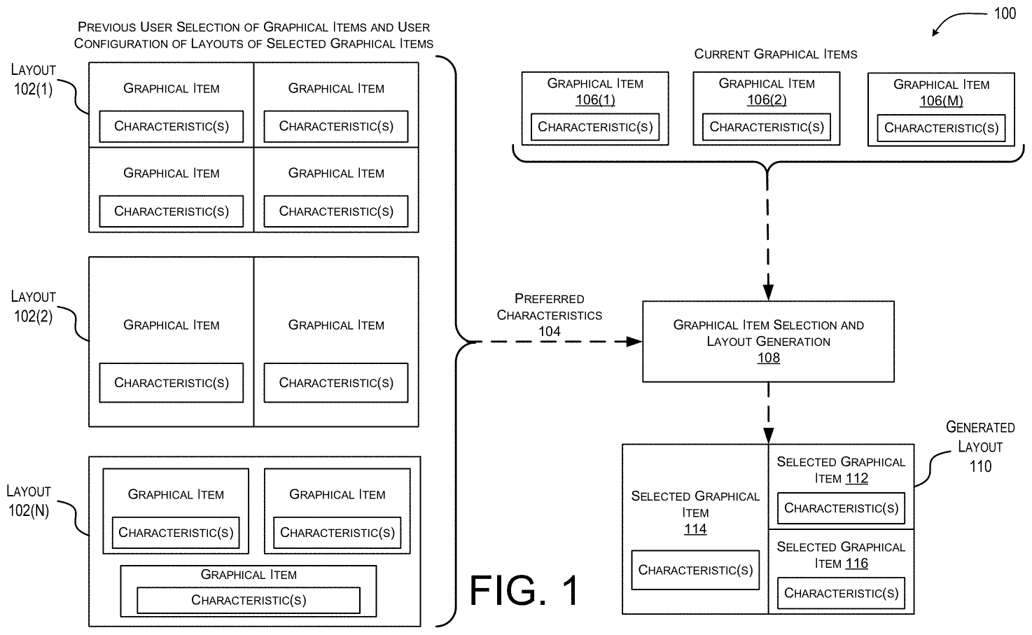

Various examples, implementations, scenarios, and aspects are described below with reference to FIGS. 1 through 11.

FIG. 1 provides a diagram 100 that illustrates an example of how previous user selection of graphical items and/or previous user configuration of layouts of the selected graphical items can be used to automatically generate one or more layouts. Given a scenario where a layout of graphical items is to be generated and displayed to a user, the system described herein can leverage a history of previous layouts 102(1) through 102(N) (where N is a positive integer number). Each layout 102(1) through 102(N) includes two or more graphical items arranged in separate display areas, and each graphical item has or is associated with characteristic(s).

In various implementations, a characteristic of a graphical item includes functionality to be executed upon selection of the graphical item. For example, the graphical item can comprise a user interface (UI) control element such as a menu of options, a selectable option in a menu of options, a button, an icon, etc. A user history of configuring a layout may reveal a user preference with respect to selecting user interface (UI) control elements based on functionality to be executed and/or arranging the selected user interface (UI) control elements into a particular layout. In a specific example, the user history may reveal that a first UI control element that executes a first function upon user selection is typically arranged in a layout on the left side of a second UI control element that executes a second function upon user selection. Moreover, the user history may reveal that a third UI control element that executes a third function is not usually selected by the user for the layout and/or is seldomly used by the user.

In various implementations, a characteristic of a graphical item includes a specific type of data displayed via the graphical item. For example, the type of data can comprise a portion of text data (e.g., a title, a sentence, a paragraph, a caption, etc.) a still image (e.g., a photo, a graph, a drawing, etc.), video frame(s) (e.g., a video game, a video clip, etc.). A user history of configuring a layout may reveal a user preference with respect to selecting graphical items based on a type of data and/or arranging the selected graphical items into a particular layout. In a specific example, the user history may reveal that an image is typically arranged in a layout above a portion of text.

In various implementations, a characteristic of a graphical item can be associated with activity (e.g., actions) that occurs in the graphical item. For example, a graphical item can be a video feed. Accordingly, a characteristic can comprise a user speaking in a video feed, a user moving in a video feed, a file being shared in a video feed, and so forth. As an example, the video feeds may be inputs to a communication session. A user history of configuring a layout of video feeds for a communication session may reveal a user preference with respect to selecting video feeds based on activity that is occurring therein and arranging the selected video feeds into a particular layout.

In various implementations, a characteristic of a graphical item can include content identification and/or content recognition. For example, a graphical item can be an image (e.g., a photo) or a video feed. Accordingly, a characteristic can comprise an identified user in the image, a recognized type of event captured in the image, a recognized type of object in the image, and so forth. A user history of configuring a layout of images and/or video feeds may reveal a user preference with respect to selecting images and/or video feeds based on the content identification or the content recognition and arranging the selected images and/or video feeds into a particular layout.

To further illustrate, layouts 102(1) through 102(N) are analyzed to determine preferred characteristics 104 with regard to selection of graphical items for display and/or configuration of the graphical items in a layout. Given a current set of graphical items 106(1) through 106(M) (where M is a positive integer number) available to be displayed, the system is configured to implement graphical item selection and layout generation 108 based on a correspondence between the characteristics of the current set of graphical items 106(1) through 106(M) and the preferred characteristics 104 determined based on an analysis of the previous layouts 102(1) through 102(M). The graphical item selection and layout generation 108 is used to automatically produce a generated layout 110 where graphical items 112, 114, 116 are selected from a current set of graphical items 106(1) through 106(M) and arranged based on their characteristics.

Consequently, a user history includes previously selected graphical items and/or the arrangement of the previously selected graphical items in a layout based on characteristics. The user history can be leveraged to determine user preferences with respect to preferred characteristics and/or preferred layouts. Consequently, the user history can enable the system described herein to automatically generate a customized layout of current graphical items to be displayed to the user. That is, the user history enables current graphical items to be selected and/or arranged in a customized layout based on a correspondence between characteristics of the current graphical items and the preferred characteristics revealed via an analysis of the user history.

In various examples, the correspondence between the characteristics of the current graphical items and the preferred characteristics revealed via an analysis of the user history can include a characteristic match or a characteristic similarity (e.g., a same or similar function to be executed, a same or similar type of data, a same or similar identified user in an image or a video feed, a same or similar type of event or activity captured in an image or a video feed, etc.).

Furthermore, when automatically generating a layout of graphical items, the preferred characteristics 104 can be used to determine a number of graphical items and corresponding display areas to be included in the layout, a size of an individual display area in the layout, or a position of an individual display area in the layout.

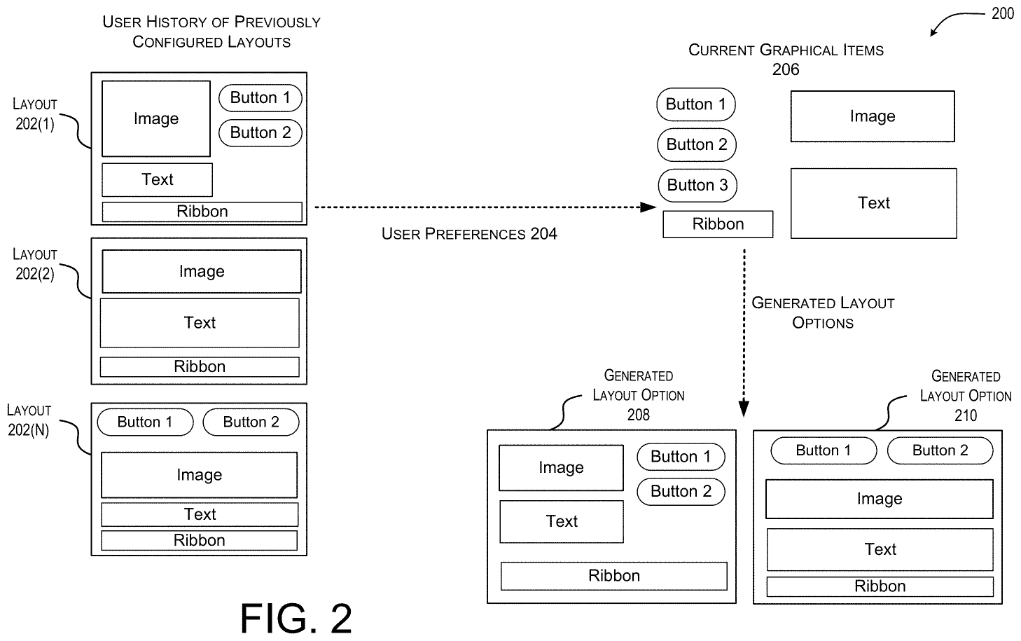

FIG. 2 provides a diagram 200 that illustrates an example that shows how previously configured layouts 202(1) through 202(N) (where N is a positive integer number) of graphical items (e.g., UI control elements and/or portions of text and images) can be used to generate a customized layout using a current set of graphical items.

As shown, layout 202(1) has an arrangement where a ribbon on the bottom spans the width of the layout 202(1), an image is in the on the top of the left side of the layout 202(1), text is in the middle on the left side of the layout 202(1), a first selectable button that executes a first function is on the right of the layout 202(1), and a second selectable button that executes a second function is on the right of the layout 202(1) underneath the first selectable button. Layout 202(2) has an arrangement where the ribbon is on the bottom and spans the width of the layout 202(2), an image is on the top of the layout 202(2), and text is in the middle of the layout 202(2). Layout 202(N) has an arrangement where the ribbon is on the bottom and spans the width of the layout 202(N), the first selectable button that executes the first function is on the top of the layout 202(N) next to the second selectable button that executes the second function, and an image is above text in the middle of the layout 202(N).

Based on an analysis of the layouts 202(1) through 202(N), the system may determine the following: the user prefers a ribbon on the bottom of a layout, the user prefers text below an image (e.g., a written explanation of a corresponding graph), and the use prefers that buttons that execute a first function and a second function are next to each other in the upper part of the layout. These user preferences 204 can be provided and applied to a set of current graphical items 206 (e.g., a first button, a second button, a third button, a ribbon, an image, and text) to generate one or more layout options (e.g., layout option 208 and layout option 210). For example, the user preferences 204 can be used to select graphical items for display. As shown, the first button that executes the first function and the second button that executes the second function are selected for display in layout options 208 and 210 based on a correspondence between characteristics, while a third button that executes a third function is not selected for display in layout options 208 and 210.

Moreover, the user preferences 204 can be used to arrange the selected graphical items. As shown, the ribbon is on the bottom of both layout options 208 and 210, and the image is above the text in both layout options 208 and 210. The difference between the layout options 208 and 210 is that in layout option 208 the first and second buttons are stacked together on the right side of the layout, while in layout option 210 the first and second buttons are next to each other on top of the layout.

Consequently, the generated layouts options 208 and 210 are customized layouts that arrange selected graphical items based on preferred user characteristics. In other words, the customized layouts arrange the selected graphical items in a manner that is the same or similar to previous arrangements of graphical items that have the same or similar characteristics.

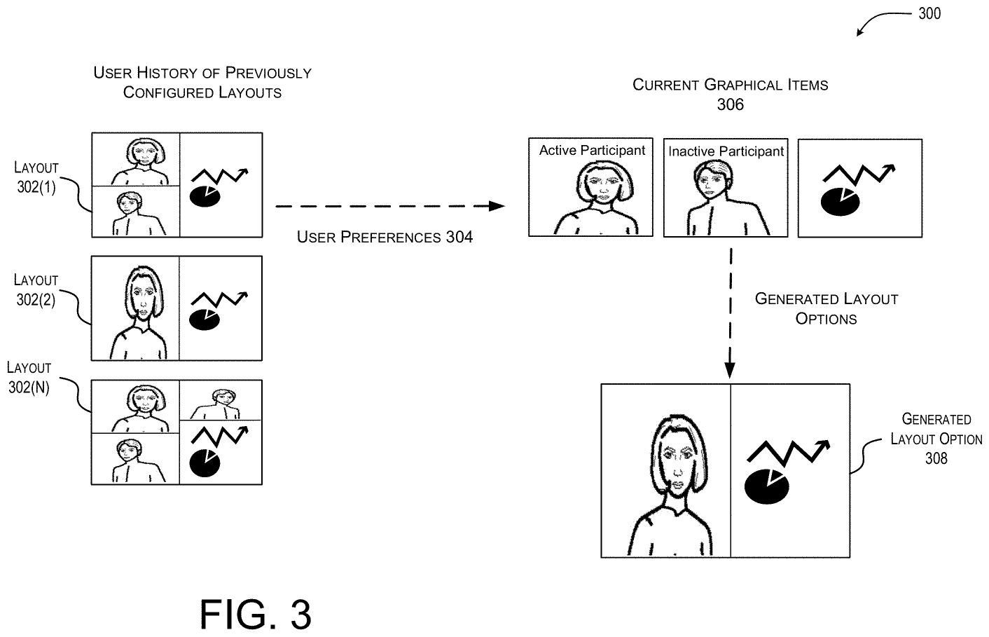

FIG. 3 provides a diagram 300 that illustrates another example that shows how previously configured layouts 302(1) through 302(N) (where N is a positive integer number) of graphical items (e.g., video feeds) can be used to generate a customized layout using a current set of graphical items. As shown, layout 302(1) has an arrangement where two active participants in a communication session are on the left while file content currently being presented and discussed in the communication session is on the right. An active participant may be a user that is speaking or moving his/or her body and extremities. Layout 302(2) has an arrangement where a single active participant in a communication session is positioned on the left while file content currently being presented and discussed in the communication session is on the right. Layout 302(N) has an arrangement where three active participants are positioned in a communication session around displayed file content on the lower right side.

Based on an analysis of the layout 302(1) through 302(N), the system may determine the following: the user prefers file content to be displayed on the right side of a layout and the user prefers to display active participants. These user preferences 304 can be provided and applied to a set of current graphical items 306 (e.g., a video feed with an active participant, a video feed with an inactive participant, a video feed with file content to be presented, etc.) to generate one or more layout options (e.g., layout option 310). For example, the user preferences 304 can be used to select graphical items for display. As shown, the active participant is selected for display in layout option 310, while the inactive participant is not selected for display in the layout option 310.

Moreover, the user preferences 304 can be used to arrange the selected graphical items. As shown in the layout option 310, the active participant is on the left and the file content is displayed on the right. Consequently, the generated layout option 310 is a customized layout with graphical items selected and arranged based on a correspondence of characteristics. In various examples, the selection and arrangement of the graphical items into a layout option improves the way in which the context of a communication session is captured.

As further described herein, the system can generate a single customized layout for a user, or the system can generate multiple customized layouts for the user. In various examples, the multiple customized layouts may be referred to as layout options or “candidate” layouts. The system may configure the multiple customized layouts for user selection. Moreover, a current set of graphical items available for selection and arrangement may all be of the same type of graphical item (e.g., a UI control element, a type of data, a video feed, etc.) or may be a mix of different types of graphical items.

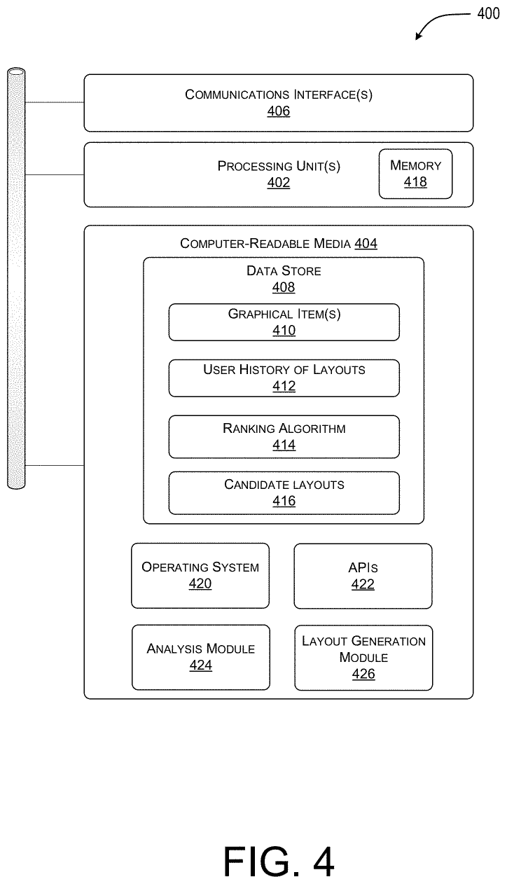

FIG. 4 illustrates a diagram that shows example components of a device 400 configured to select graphical item(s) and generate one or more layouts for a user. In various examples, the device 400 may represent, but is not limited to, a server computer, a desktop computer, a web-server computer, a personal computer, a mobile computer, a laptop computer, a tablet computer, a game console and/or a gaming device, a personal data assistant (“PDA”), a telecommunication device, a computer navigation type client computing device such as a satellite-based navigation system including a global positioning system (“GPS”) device, a wearable device, a virtual reality (“VR”) device, an augmented reality (“AR”) device, a mixed reality (“MR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device.

As illustrated, the device 400 includes one or more processing unit(s) 402, computer-readable media 404, and communication interface(s) 406. The components of the device 400 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as processing unit(s) 402, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 404, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 406 may represent, for example, network interface controllers (“NICs”) or other types of transceiver devices to send and receive communications over a network. Such network interface(s) may include one or more network interface controllers (NICs) or other types of transceiver devices to send and receive communications and/or data over a network. Moreover, device 400 can include input/output (“I/O”) interfaces such as user input devices including peripheral input devices (e.g., a game controller, a keyboard, a mouse, a pen, a voice input device such as a microphone, a touch input device, a gestural input device, a camera, and the like) and/or output devices including peripheral output devices (e.g., a display, a printer, audio speakers, a haptic output device, and the like).

In the illustrated example, computer-readable media 404 includes a data store 408. In some examples, data store 408 includes data storage such as a database, data warehouse, or other type of structured or unstructured data storage. In some examples, data store 408 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XIVIL”) tables, for example.

The data store 408 may store data for the operations of processes, applications, components, and/or modules stored in computer-readable media 404 and/or executed by processing unit(s) 402. For instance, in some examples, data store 408 may store graphical items 410 (e.g., UI control elements, images, text, video feeds for a communication session, etc.), a user history of previously configured layouts 412, a ranking algorithm 414, and the candidate layouts 416 generated based on an analysis of the user history and a determination of user preferences.

Alternatively, some or all of the above-referenced data can be stored on separate memories 418 on board one or more processing unit(s) 402 such as a memory on board a CPU-type processor, a GPU-type processor, an FPGA-type accelerator, a DSP-type accelerator, and/or another accelerator.

In the example of FIG. 4, the computer-readable media 404 can also include operating system 420 and application programming interface(s) 422 configured to expose the functionality and the data of the device 400 to other devices. Additionally, the computer-readable media 404 can include one or more modules such as an analysis module 424 and a layout generation module 426. The number of illustrated modules is just an example, and the number may vary higher or lower. That is, functionality described herein in association with the illustrated modules may be performed by a fewer number of modules or a larger number of modules on one device or spread across multiple devices.

The analysis module 424 is configured to determine analyze the user history of configuring layouts 412 and determine preferred characteristics of the user. The preferred characteristics can be passed on to the layout generation module 426. The layout generation module 426 uses the preferred characteristics to select and/or arrange graphical items into one or more layouts, as described herein.

In various examples, the layout generation module 426 can rank multiple candidate layouts and display the candidate layouts based on the ranking. The ranking can be determined by a ranking algorithm 414 that takes, as input, characteristics of graphical items (e.g., functionality executed by a UI control element, a type of data, participant activity in a communication session, a user identification, a type of recognized object, etc.) and applies parameters to the characteristics to determine which graphical items are to be displayed and/or the arrangement in which the graphical items are to be displayed. Stated another way, the parameters of the ranking algorithm 414 can be established to help determine (e.g., recommend) an optimal layout.

In some instances, the ranking algorithm 414 can be learned based on a user's personal history of configuring layouts. That is, at least some of the aforementioned parameters can be learned and/or adjusted based on previous graphical item selections and/or previous arrangements of selected graphical items. Consequently, at least some of the parameters of the algorithm used to rank the different layouts can be tuned and/or updated based on a user's personal history. This enables the algorithm to adapt to a “style” and/or tailor to behaviors of a user as they relate to configuring a layout of graphical items. Additionally or alternatively, the parameters of the algorithm can be learned and/or adjusted based on a general history of a population of users.

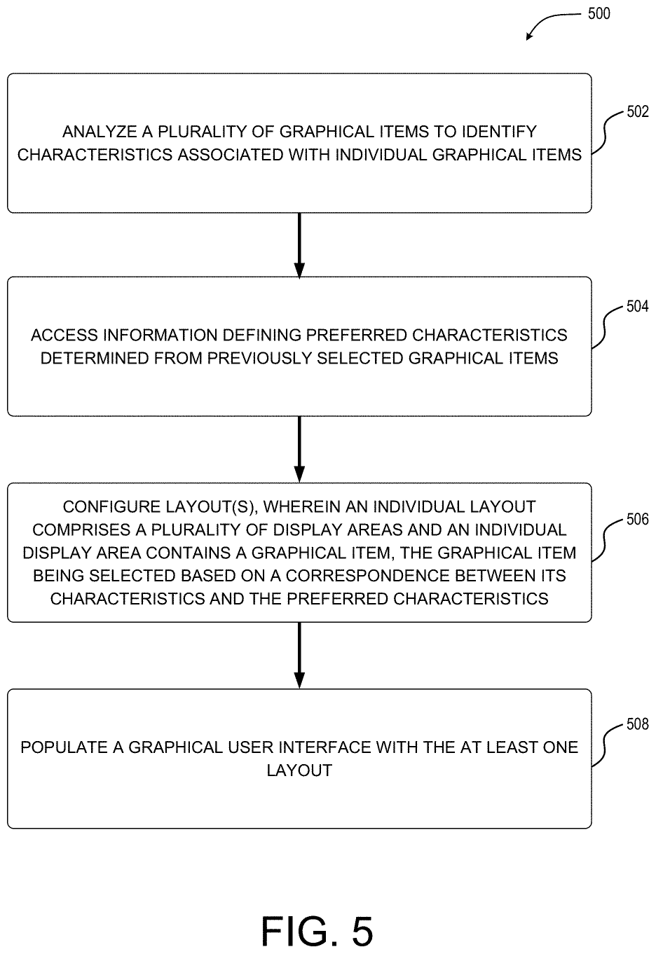

FIGS. 5, 7, and 10 each illustrate an example flowchart. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can start and/or end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., device 400) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

FIG. 5 is a diagram 500 of an example flowchart that illustrates operations directed to automatically selecting and/or configuring one or more layout(s) based on preferred characteristics of a user.

At operation 502, a plurality of graphical items are analyzed to identify characteristics associated with individual graphical items. The plurality of graphical items comprises a current set of graphical items available to be arranged in a layout and rendered for display.

At operation 504, information defining preferred characteristics determined from previously selected graphical items is accessed.

At operation 506, at least one layout is configured. An individual layout includes a plurality of display areas. An individual display area of the layout contains at least one graphical item. As described above, a graphical item can be selected for the layout based on a correspondence between the characteristics of the graphical item and the preferred characteristics.

At operation 508, a graphical user interface is populated with the at least one layout.

As described above, the graphical items can include one or more of UI control elements, portions of text, images, video feeds, or other items that can be displayed to a user. Consequently, the system described herein can provide contextually-relevant UI layouts while minimizing or eliminating the need for manual input that may be required for a customization process. Accordingly, the user does not have to spend a considerable amount of time and computing resources that are usually required for the traditional, labor-intensive process of manually generating a layout for a particular purpose.

In various implementations, the disclosed system implements techniques to assist a user responsible for configuring a layout for a communication session. For example, the person may be a host of the communication session or a producer of the communication session. The graphical items of a communication session can be video feeds that are captured and subsequently shared, so the participants can view and/or hear content of the communication session. In one example, the content of a communication session can comprise video feeds associated with a broadcast presentation (e.g., a presentation by high-level employees of a company or a department to all the other employees located around the world). In another example, the content of a communication session can comprise video feeds associated with a group collaboration during a video conference (e.g., a team of employees using personal devices to discuss a work project).

Some conventional communication systems enable a host or a producer to manage how a communication session is being conducted. In particular, at a given moment, the host or the producer decides which video feeds are to be displayed to those attending or participating in the communication session. The host or the producer of the communication session typically has to manually monitor various video feeds of the communication session for relevant activity and manually select video feeds to be displayed in a graphical user interface that is shared with the participants of the communication session. This can be a burdensome and time-consuming process.

A participant of a communication session is a person that is viewing the content of the communication session. To this end, a participant may be sitting in a crowd viewing the shared content at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home. In some instances, the participant may be in range of a camera, or other image and/or audio capture device such that actions and/or sounds can be captured (e.g., recorded) and shared as part of the content of the communication session.

In various examples, the communication session is configured to display selected video feeds in a layout with multiple display areas, where each selected video feed is contained within a display area. For example, a first display area of the layout may contain a video feed of a main presenter in the communication session, a second display area of the layout may contain a video feed of an individual interacting with the main presenter, a third display area of the layout may contain a video feed of a person in the audience, and so forth. The display areas may vary in size, and the number of display areas may vary from one layout to the next (e.g., a number of display areas in a layout can include one, two, three, four, five, six, and so on). In some cases, the sizes of the individual display areas in a layout decrease as the number of display areas in the layout increases (e.g., sizes are reduced to make room for additional display areas).

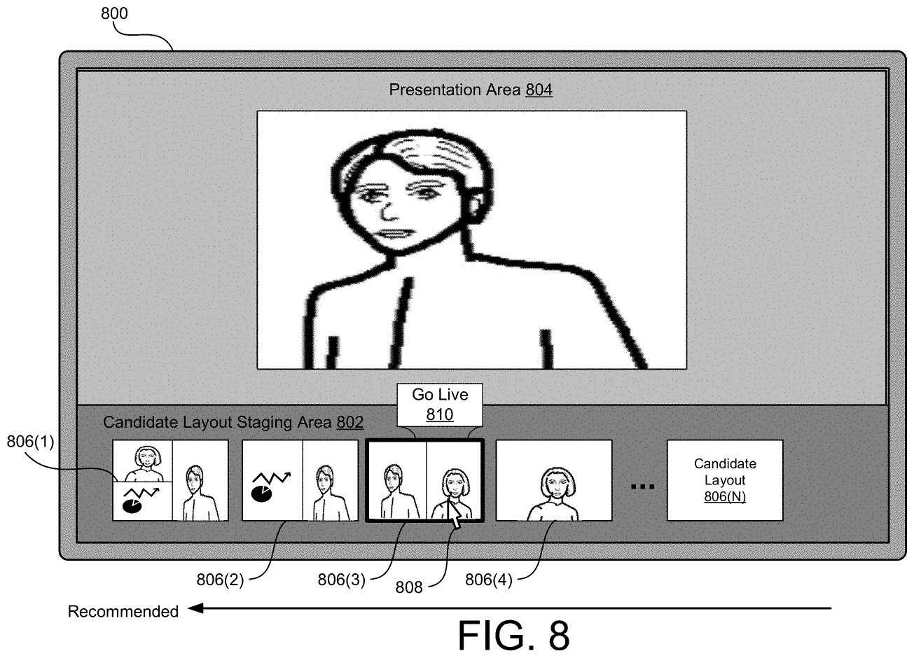

In various implementations, the system can populate a staging area, for the host or the producer, with candidate layouts. The staging area comprises a portion of a graphical user interface that is presented to a person responsible for configuring a layout of the communication session. Example graphical user interfaces, described herein with respect to FIGS. 8, 9A, 9B, and 11, display information to the person responsible for configuring a layout. The staging area allows the host or the producer to preview different candidate layouts during a communication session as activity that captures the context of the communication session is detected. The activity that captures the context of the communication session likely changes over a period of time (e.g., different people speak, an audience reacts to an event, a new document is shared, a presenter moves from one location on the stage to another location, etc.).

Using the staging area, the host or the producer can identify and select a candidate layout that he or she believes best captures the context of the communication session (e.g., at a particular point in time or during a period of time). Moreover, the staging area enables the host or the producer to efficiently transition the selected candidate layout into a presentation area of the graphical user interface, so it can be shared with the participants of the communication session.

Consequently, a view that includes the staging area can be a unique view for the host or the producer of the communication session in that it includes the staging area as well as a presentation area that includes the content currently being shared with the participants of the communication session. The graphical user interface that comprises the view with the staging area is configured with a control that enables a selection of a candidate layout so that it can be transitioned (e.g., moved, pushed, made live, etc.) to the presentation area.

To generate the candidate layouts, the system is configured to monitor video feeds being input to a communication session in order to detect activity (e.g., events) that is relevant to the context of the communication session. The candidate layouts are generated based on the detected activity. For example, an event that is relevant to the context of the communication session can include an audible signal such as a participant speaking. In another example, an event that is relevant to the context of the communication session can include physical movement (e.g., a participant turns his or her head, a participant walks across the stage, a participant stands up, a participant raises a hand or performs a hand gesture, etc.). To qualify as an event for detection purposes, the amount of physical movement may need to exceed a threshold amount of movement. In yet another example, an event that is relevant to the context of the communication session can include audience reactions (e.g., a participant clapping, a participant laughing, a participant frowning, etc.). In further examples, an event that is relevant to the context of the communication session can include: a participant joining the communication session, a participant leaving the communication session, or any other types of activity determined to provide value or contribute to understanding the context of the communication session. Consequently, based on detection of activity that is relevant to the context of the communication session, the system can automatically populate a staging area with a variety of layouts that capture the activity in a different arrangement. Then, a producer can preview the layouts and efficiently identify a specific layout to share with the participants of the communication session.

In various examples, the video feeds being monitored can be a subset of a total number of video feeds being input to the communication session. Stated another way, the video feeds being monitored can be designated or tagged for monitoring in advance. The designation or tag can be based on a participant being a primary participant. A primary participant includes a person expected and/or known to contribute to the discussion of a topic of the communication session (e.g., expected and/or known to dominate the discussion). The designation or tag may be applied prior to or during the communication session. In these examples, the designation or tag can be used to ensure that the participants of the communication session are provided with a layout that captures the more relevant activity performed by the more important people.

In further examples described herein, the system can rank the candidate layouts and display the candidate layouts in the staging area based on the ranking. The ranking can be determined by an algorithm that takes information about the detected activity (e.g., participants performing the activity, type of activity, etc.) as inputs and applies parameters to the information to determine which activity is to be displayed and/or the way in which the activity is to be displayed. Stated another way, the parameters of the algorithm can be established to help determine (e.g., recommend) an optimal layout that accentuates the detected activity or the more relevant detected activity. One example parameter of the algorithm can be based on importance of individual participants and/or individual video feeds and can be applied to prioritize which participants and/or video feeds to display so activity performed by more important people or video feeds is shared. Another example parameter of the algorithm can be based on importance of different types of detected activity (e.g., a participant speaking, a participant raising a hand, audience reactions, etc.) and can be applied to prioritize which types of detected activity are shared. A further example parameter of the algorithm can be used to prioritize a number of display areas (e.g., one, two, three, four, and so on) to be displayed in order to best capture the detected activity. Even a further example parameter of the algorithm can be used to prioritize the positioning of the video feeds within various display areas.

In some instances, the algorithm can be learned based on a user's personal history of producing or hosting communication sessions. That is, at least some of the aforementioned parameters can be learned and/or adjusted based on previously layout selections by the user based on a current state of detected activity. For example, a first user may rarely may select and share a video feed that captures the audience in a display area of a current layout at a moment when there is lots of cheering and applause, rather choosing to have the current layout stay focused on the detected activity that causes the cheering and applause (e.g., a presenter providing an award to a recipient). In contrast, a second user may often select and share a video feed of the audience in a display area of a current layout at a moment when the audience cheers and provides applause.

In another example, a first user may prefer to display a main presenter in a display area on the left side of the current layout, while a second user may prefer to display the main presenter in a display area on the right side of the current layout. Consequently, at least some of the parameters of the algorithm used to rank the different layouts can be tuned and/or updated based on a user's personal history of layout selections in response to detected activity. This enables the algorithm to adapt to a “style” and/or tailor to behaviors of the user as the user manages more communication sessions. Additionally or alternatively, the parameters of the algorithm can be learned and/or adjusted based on a general history of a population of users (e.g., common layout selections considering detection of particular activity).

The staging area can be configured with a control that enables user selection of one of the plurality of candidate layouts. Using the control, a user can activate (e.g., make live, push, move, etc.) a staged layout so that it is shared with the participants of the communication session.

In additional examples described herein, the system can configure and display a sequential timeline for a communication session. The sequential timeline can define scheduled or planned segments of the communication session. For example, a communication session agenda may identify an introduction segment, a segment for the discussion of a first topic by a first speaker, a segment for the discussion of a second topic by a second speaker, a conclusion segment, and a question and answer segment. The sequential timeline allows the producer to generate a sequence of layouts and layout transitions in advance (e.g., prior to the communication session starting, prior to a particular segment of the communication session starting, etc.).

Each segment can include information regarding scheduled activity (e.g., participants to speak about a topic, content items to be shared, etc.). Since different segments are likely to be associated with different activity (e.g., different participants speaking, different content items to display, etc.), an individual segment can be pre-associated with designated video feeds expected to capture or contain the activity of the individual segment. Based on navigation of a cursor to a position on the sequential timeline, the system provides a user with a plurality of candidate layouts that can be selected and added to the sequential timeline. The candidate layouts in these examples can include the designated video feeds. Stated another way, the candidate layouts in these examples can be templates that display one or more designated video feeds differently. For instance, a first designated video feed may be associated with a camera or other video capture device positioned to capture the first speaker, a second designated video feed may be associated with a camera or other video capture device positioned to capture a second speaker expected to interact with the first speaker, a third designated video feed may be associated with a camera or other video capture device positioned to capture a conference room in a remote office, a fourth designated video feed may be configured to display a content item (e.g., a slideshow) to be presented, and so forth.

After candidate layouts are added to the defined segments of the sequential timeline, the sequential timeline can be used to automatically implement the transitions from a current layout to a next layout.

Similar to the discussion above, the system can use an algorithm with one or more of the example parameters to rank the candidate layouts for a particular position on the sequential timeline. The ranking can be based on information provided in advance by the agenda of the communication session (e.g., type of segment, a scheduled speaker, participants expected to interact with a scheduled speaker, etc.). Additionally or alternatively, the ranking can be based on actual detected activity that occurs during a rehearsal (e.g., a dry run) of the communication session. In some examples, the algorithm can be learned based on a user's personal history of producing or managing communication sessions. That is, at least some of the aforementioned parameters can be learned and/or adjusted based on previously layout selections by the user considering detection of particular activity and/or previously composed sequential timelines.

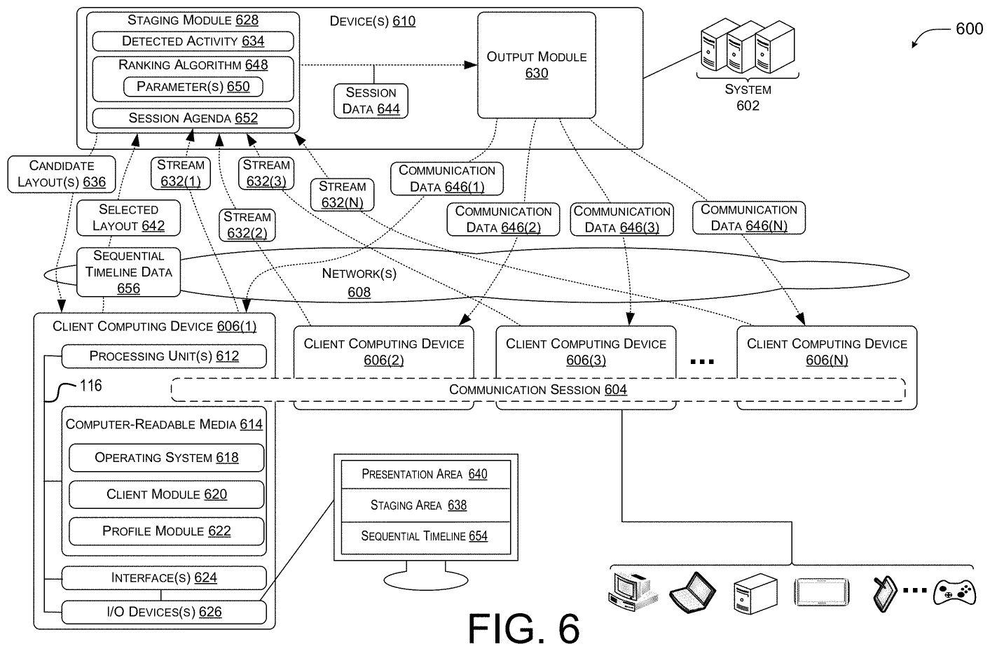

FIG. 6 is a diagram illustrating an example environment 600 in which a system 602 can operate to populate a staging area and/or a sequential timeline of a graphical user interface with candidate layouts. As described above, the staging area can be presented to a person responsible for configuring a layout of video feeds for a communication session 604 (e.g., a host, a producer, etc.). Accordingly, the graphical user interface can comprise a view for this person. The staging area allows the host or the producer to preview the different candidate layouts during the communication session 604 as activity that captures the context of the communication session 604 is detected. The host or the producer can then identify and select a candidate layout that he or she believes best captures the context of the communication session 604.

In the example of FIG. 6, the communication session 604 is implemented between a number of client computing devices 606(1) through 606(N) (where N is a positive integer number having a value of two or greater). A client computing device may comprise the example device 400. The client computing devices 606(1) through 606(N) enable users to attend and/or participate in the communication session 604, and thus a user may be referred to herein as a participant of or an attendee to the communication session 604. The communication session 604 in this example is hosted, over one or more network(s) 608, by the system 602. That is, the system 602 can provide a service that enables users of the client computing devices 606(1) through 606(N) to view and/or hear people during the communication session 604 and/or to view and/or hear content items shared during the communication session 604. A content item may include, for example, a data file (e.g., a document, a spread sheet, a presentation, a video clip, etc.), a computer application (e.g., a computer-aided design (CAD) application that the user may use to show three-dimensional models, a media player application that the user may use to show a video, etc.), a web browser, a user desktop, and/or any other type of content item suitable for sharing during a communication session 604.

A participant can view content of the communication session 604 live as activity occurs, or alternatively, via a recording at a later time after the activity occurs. In examples described herein, individual ones of client computing devices 606(1) through 606(N) participating in the communication session 604 are configured to receive and render for display, on a user interface of a display screen, communication data. The communication data can comprise a collection of various streams, or video feeds, of live and/or recorded content. For example, an individual video feed can comprise audio and visual data that captures the appearance and speech of a user participating in the communication session. Another example of a video feed can comprise media data that includes an avatar of a user participating in the conference session along with audio data that captures the speech of the user. Yet another example of a video feed can comprise media data that includes a content item displayed on a display screen and/or audio data that captures the speech of a user.

In various examples, the communication session 604 displays the content being communicated and/or shared in a layout. As described above, each display area of a layout may be populated with one or more participants of the communication session 604 or a content item. The display areas may vary in size, and the number of display areas may vary from one layout to the next (e.g., a number of display areas in a layout can include one, two, three, four, five, six, and so on). In some cases, the sizes of the individual display areas in a layout decrease as the number of display areas in the layout increases (e.g., sizes are reduced to make room for additional display areas).

The system 602 includes device(s) 610. In various examples, the device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 604. As an example, the system 602 may be managed by entities such as SLACK, WEBEX, GOTOMEETING, GOOGLE, FACEBOOK, etc. As an alternative, the communication session 604 can be hosted by a client computing device. For instance, functionality implemented by the system 602 can be performed by one of client computing devices 606(1) through 606(N) utilizing peer-to-peer technologies and/or mobile-to-mobile scenarios.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

Client computing device(s) 606(1) through 606(N) of the various classes and device types can represent any type of computing device having one or more processing unit(s) 612 operably connected to computer-readable media 614 such as via a bus 616, which in some instances can include one or more of a system bus, a data bus, an address bus, a PCI bus, a Mini-PCI bus, and any variety of local, peripheral, and/or independent buses.

Executable instructions stored on computer-readable media 614 may include, for example, an operating system 618, a client module 620, a profile module 622, and other modules, programs, or applications that are loadable and executable by processing units(s) 612.

Client computing device(s) 606(1) through 606(N) may also include one or more interface(s) 624 to enable communications between client computing device(s) 606(1) through 606(N) and other networked devices, such as device(s) 610, over network(s) 608.

In the example of FIG. 6, client computing device 606(1) is associated with a host or a producer of the communication session 604. As described above, the host or the producer is likely a person responsible for managing the communication session 604. For instance, a producer can be a dedicated person (e.g., an IT administrator) tasked with ensuring the communication session 604 is conducted smoothly. As shown, client computing device 606(1) is in some way connected to an input/output device 626 such as display device (e.g., a display screen) which is configured to display a graphical user interface.

In the example environment 600 of FIG. 6, client computing devices 606(1) through 606(N) may use their respective client modules 620 to connect with one another and/or other external device(s) in order to participate in the communication session 604. For instance, a first user may utilize a client computing device 606(1) to participate in or attend a communication session where the first user communicates with a second user of another client computing device 606(2) who also participates in or attends the communication session. When executing client modules 620, the users may share data, which may cause the client computing device 606(1) to connect to the system 602 and/or to the other client computing devices 606(2) through 606(N) over the network(s) 608.

The client computing device(s) 606(1) through 606(N) may use their respective profile module 622 to generate participant (e.g., attendee) profiles, and provide the participant profiles to other client computing devices and/or to the device(s) 610 of the system 602. A participant profile may include one or more of an identity of a user or a group of users (e.g., a name, an alias, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 6, the device(s) 610 of the system 602 includes a staging module 628 and an output module 630. In this example, the staging module 628 is configured to receive, from individual client computing devices such as client computing devices 606(1) through 606(N), media streams 632(1) through 632(N). Media streams can comprise a video feed (e.g., audio and visual data associated with a user), an audio feed which is to be output with a presentation of an avatar of a user (e.g., an audio only experience), text data (e.g., text messages), file data and/or screen sharing data, and so forth. Thus, the staging module 628 is configured to receive a collection of various media streams 632(1) through 632(N) during a live viewing of the communication session 604 (the collection being referred to herein as media data 632). In some scenarios, not all the client computing devices that participate in the communication session 604 provide a media stream. For example, a client computing device may only be a “consuming”, or a “listening”, device such that it only receives data associated with the communication session 604 but does not provide any data to the communication session 604 to be shared with others.

In various examples, the staging module 628 is configured to monitor the media data 632 being input to the communication session 604 in order to detect activity 634 (e.g., events) that is relevant to the context of the communication session 604. The staging module 628 can generate candidate layouts based on the detected activity and transmit the candidate layouts 636 to the client computing device 606(1) associated with the host or the producer of the communication session 604 so that a staging area 638 of the graphical user interface can be populated with the candidate layouts. Once populated, the host or the producer can identify and select a candidate layout that can be pushed to a presentation area 640 of the graphical user interface. The presentation area 640 reflects the content of the communication session 604 that is being shared with the participants (e.g., as part of a live broadcast). In this way, the graphical user interface enables the host or the producer to preview a next layout while viewing the content of the communication session 604 being shared with the participants in a current layout.

The staging module 628 is configured to monitor for and detect activity, or events, that is/are relevant to the context of the communication session 604. An event can include an audible signal such as a participant speaking. An event can also include physical movement (e.g., a participant turns his or her head, a participant walks across the stage, a participant stands up, a participant raises a hand or performs a hand gesture, etc.). In various examples, the detection of an event can be based on recognizing that an amount of physical movement (e.g., body and/or facial movement) of a participant exceeds a threshold amount. In other examples, the detection of an event can be based on recognizing that physical movement deviates from a previous position (e.g., a standard body pose, a normal facial expression, etc.). In further examples, an event can include audience reactions (e.g., participant(s) clapping, participant(s) laughing, etc.), a participant joining the communication session, a participant leaving the communication session, or any other types of actions determined to provide value or contribute to understanding the context of the communication session.

In some examples, detected movement and/or detected sounds produced by a participant can be mapped to a specific type of target event the staging module 628 is monitoring for.

In further examples, the streams being monitored by the staging module 628 can be a subset of a total number of streams being input to the communication session. Such streams can be designated or tagged for monitoring in advance. The designation or tag can be based on a participant being a primary participant. A primary participant includes a person expected and/or known to contribute to the discussion of a topic of the communication session (e.g., expected and/or known to dominate the discussion). The designation or tag may be applied prior to or during the communication session. In these examples, the designation or tag can be used to ensure that the participants of the communication session are provided with a layout that captures the more relevant activity performed by the more important people.

After previewing the candidate layouts, a host or a producer makes a selection. The client computing device 606(1) transmits the selection of a candidate layout 642 back to the staging module 628. The staging module 628 is then configured to share the selected layout with the participating client computing devices 606(1) through 606(N). Consequently, the staging module 628 may be configured to generate session data 644 based on the received media data 632 and the selected layout 642 and/or pass the session data 644 to the output module 630.

The output module 630 is configured to transmit (e.g., broadcast) communication data 646 to the client computing devices 606(1) through 606(N) as part of a live or recorded viewing of the communication session 604. As shown, the output module 630 transmits communication data 646(1) to client computing device 606(1), transmits communication data 646(2) to client computing device 606(2), transmits communication data 646(3) to client computing device 606(3), and transmits communication data 646(N) to client computing device 606(N), etc.

In various examples, the staging module 628 can use a ranking algorithm 648 to rank the candidate layouts 636 that are transmitted to the client computing device 606(1) so that the candidate layouts can be displayed in the staging area 638 based on the ranking. The ranking algorithm 648 can receive, as inputs, information about the detected activity 634 (e.g., participants performing the activity, type of activity, etc.) and apply parameter(s) 650 to the information to determine which activity is to be displayed and/or the way in which the activity is to be displayed. Accordingly, the parameters 650 of the ranking algorithm 648 can be established to help determine (e.g., recommend) an optimal layout that accentuates the detected activity or the more relevant detected activity.

An example parameter 650 of the ranking algorithm 648 can be based on importance of individual participants and/or individual streams and can be applied to prioritize which participants and/or streams to display so activity performed by more important people or streams is shared. Another example parameter 650 of the ranking algorithm 648 can be based on importance of different types of detected activity (e.g., a participant speaking, a participant raising a hand, etc.) and can be applied to prioritize which types of detected activity are shared. A further example parameter 650 of the ranking algorithm 648 can be used to prioritize a number of display areas to be displayed in order to best capture the detected activity. Even a further example parameter 650 of the ranking algorithm 648 can be used to prioritize the positioning of the streams within various display areas.

The ranking algorithm 648 can be learned based on a producer's personal history of producing communication sessions. That is, at least some of the aforementioned parameters 650 can be learned and/or adjusted based on behavioral characteristics (e.g., previous layout selections) of the host or the producer considering detection of particular activity. Consequently, at least some of the parameters 650 of the ranking algorithm 648 used to rank the different layouts can be tuned and/or updated based on a person history of layout selections in response to detected activity.

Machine learning techniques can be utilized to determine the parameters 650 for a particular host or producer. Example machine learning techniques include unsupervised learning, semi-supervised learning, classification analysis, regression analysis, clustering, etc. One or more predictive models may also be utilized, such as a group method of data handling, Naive Bayes, k-nearest neighbor algorithm, majority classifier, support vector machines, random forests, boosted trees, Classification and Regression Trees (CART), neural networks, ordinary least square, and so on. Additionally or alternatively, the parameters of the algorithm can be learned and/or adjusted based on a general history of a population of users (e.g., common layout selections considering detection of particular activity).

In additional examples described herein, the staging module 628 can use an agenda 652 for the communication session 604 to configure and display a sequential timeline 654 in the graphical user interface. The sequential timeline 654 can define scheduled or planned segments of the communication session 604. For example, the agenda 652 may identify an introduction segment, a segment for the discussion of a first topic by a first speaker, a segment for the discussion of a second topic by a second speaker, a conclusion segment, and a question and answer segment. The sequential timeline 654 allows the host or the producer to generate a sequence of layouts and layout transitions in advance (e.g., prior to the communication session 604 starting, prior to a particular segment of the communication starting, etc.).

Since different segments are likely to be associated with different activity (e.g., different participants speaking, different content items to display, etc.), an individual segment can be pre-associated with designated streams (e.g., feeds captured and generated by designated cameras) expected to capture or contain the activity (e.g., a participant) of the individual segment. Based on navigation of a cursor to a position on the sequential timeline 654, the staging module 628 is configured to provide candidate layouts 636 that can be selected and added to the sequential timeline 654. The candidate layouts in this example can be templates that display one or more designated streams differently. For instance, a first designated stream may be associated with a camera or other video capture device positioned to capture the first speaker, a second designated stream may be associated with a camera or other video capture device positioned to capture a second speaker expected to interact with the first speaker, a third designated stream may be associated with a camera or other video capture device positioned to capture a conference room in a remote office, a fourth designated stream may be configured to display a content item (e.g., a slideshow) to be presented, and so forth.

After or when candidate layouts are added to the defined segments of the sequential timeline 654, the client computing device 606(1) can transmit the sequential timeline data 656 (e.g., an added selection of a candidate layout) to the staging module 628 so that it can be used in the session data 644 to automatically implement the transitions from a current layout to a next layout.

Similar to the discussion above, the system can use a ranking algorithm 648 with one or more of example parameters 650 to rank the candidate layouts to be displayed in association with a particular position on the sequential timeline 654. The ranking can be based on information provided in advance by the agenda 652 of the communication session (e.g., type of segment, a scheduled speaker, participants expected to interact with a scheduled speaker, etc.). In some implementations, the ranking can be based on actual detected activity that occurs during a rehearsal (e.g., a dry run) of the communication session 604.

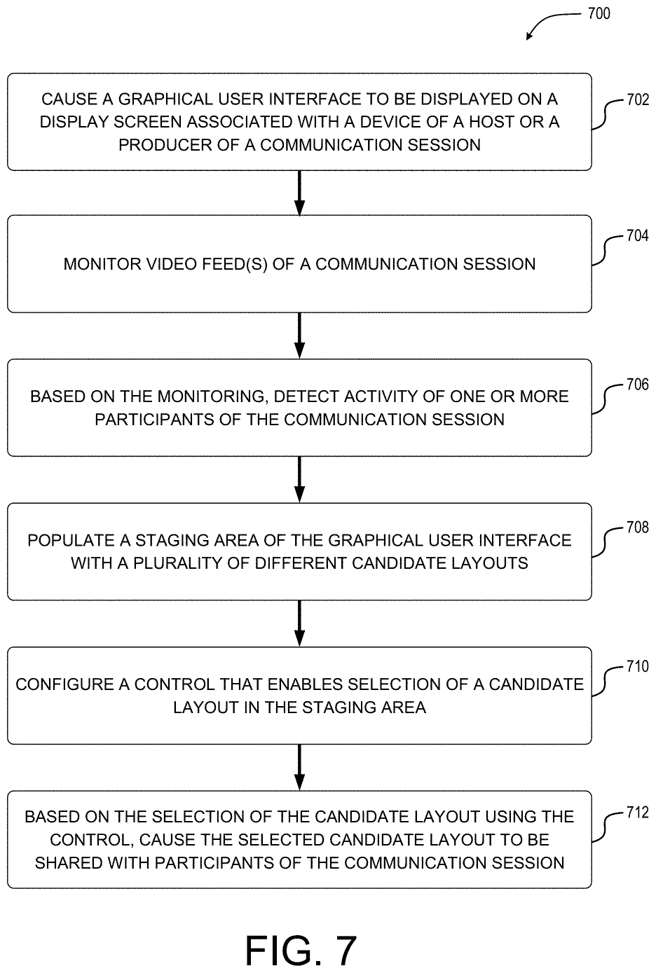

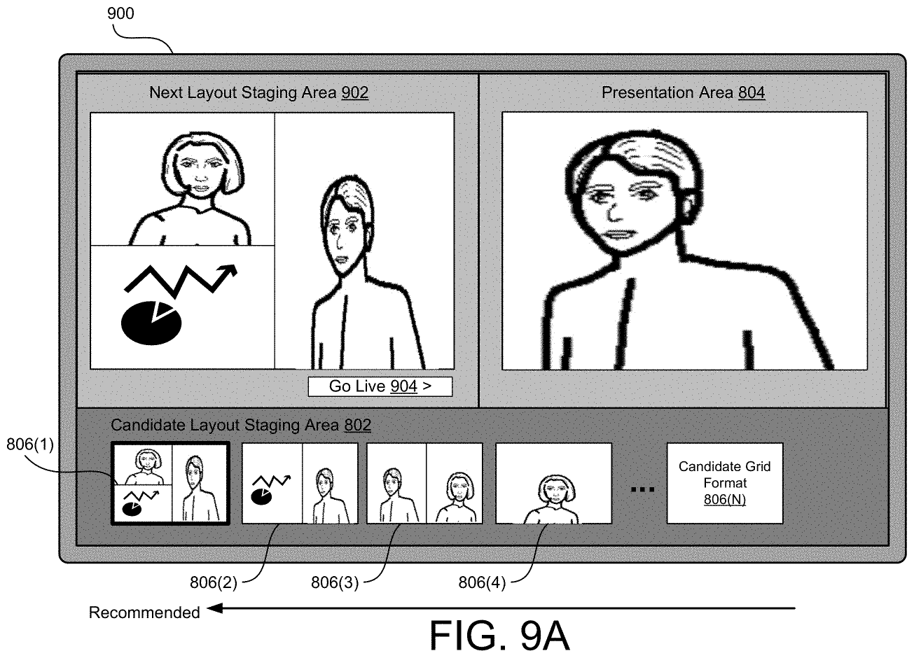

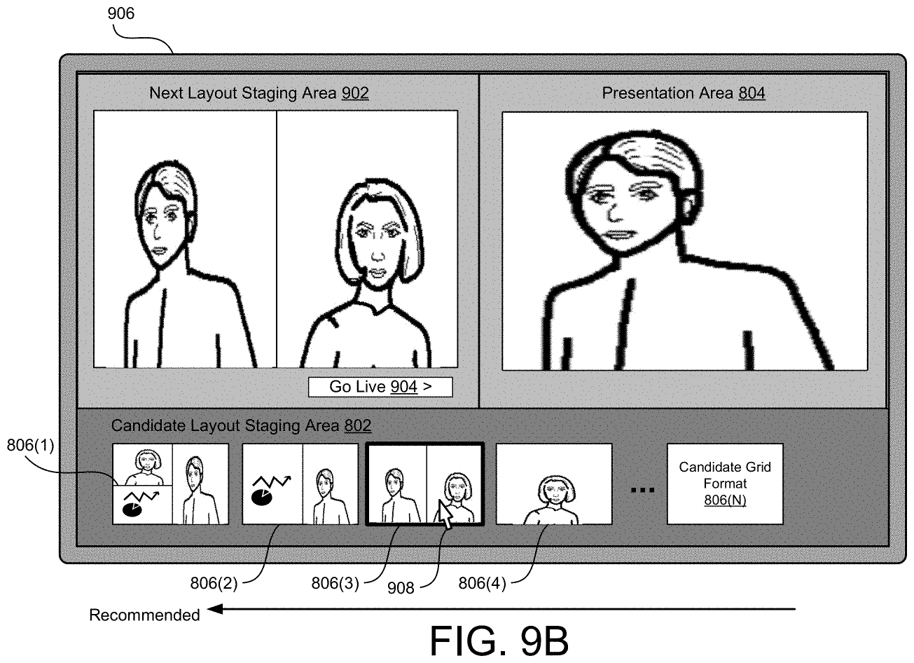

The operations illustrated in FIG. 7 can be implemented in association with the example graphical user interfaces described herein with respect to FIGS. 8, 9A, and 9B. For instance, the various device(s) and/or module(s) in FIGS. 4 and/or 6 can generate, receive, transmit, and/or display data associated with content of a communication session (e.g., live content, recorded content, etc.) in order to compose a view for a host or a producer.

FIG. 7 is a diagram of an example flowchart 700 that illustrates operations directed to populating a staging area with candidate layouts in order to enable identification and selection of a next layout to be shared and displayed in a communication session.

At operation 702, a graphical user interface is caused to be displayed on a display screen associated with a device of a host or a producer of a communication session.

At operation 704, video feeds being input to the communication session are monitored. As described above, in various examples, the video feeds being monitored can be designated or tagged for monitoring in advance. For instance, the designation or tag can be based on a participant being a primary participant. The designation or tag may be applied prior to or during the communication session. In these examples, the designation or tag can be used to ensure that the participants of the communication session are provided with a layout that captures the more relevant activity performed by the more important people.

At operation 706, activity is detected based on the monitoring. The activity may be performed by one or more of the participants of the communication session. For example, a participant may begin to speak. In another example, a participant may perform some threshold amount of physical movement. In a further example, a participant may share a content item (e.g., a slide deck, a video clip, an audio clip, etc.).

At operation 708, a staging area of the graphical user interface is populated with a plurality of different candidate layouts. As described above, the different candidate layouts capture at least part of the detected activity in a different layout so that a producer can preview the different candidate layouts and identify a specific candidate layout to share with the participants of the communication session.

At operation 710, a control that enables selection of a candidate layout in the staging area is configured. Examples of how a producer can use various controls to select a candidate layout to be transitioned to a presentation area is described herein with respect to FIGS. 8, 9A, and 9B.

At operation 712, based on selection of the candidate layout using the control, a selected candidate layout is shared with the participants of the communication session.

FIG. 8 illustrates an example graphical user interface 800 configured to display a view into a communication session for a host or a producer. The view includes a candidate layout staging area 802 and a presentation area 804 (e.g., a “live event” area). As described above, the presentation area 804 includes content of a communication session that is currently being shared (e.g., as part of a live broadcast) with the participants of a communication session. In FIG. 8, the current layout being shared in the presentation area comprises a single video feed that captures a main presenter, which is displayed in a single display area, for example.

The candidate layout staging area 802 includes a plurality of different candidate layouts 806(1) through 806(N) (where N is a positive integer number having a value of one or more). The staging module 628 is configured to detect activity and populate the candidate layout staging area 802 with the different candidate layouts 806(1) through 806(N). For example, candidate layout 806(1) includes three display areas where the display area on the right includes the video feed that captures the main presenter, the display area in the upper left includes a video feed that captures a participant that is responding to something said by the main presenter, and the display area in the lower left includes a video feed that captures a content item shared by a participant. The candidate layout 806(2) includes two display areas where the display area on the right includes the video feed that captures the main presenter, and the display area on the left includes a video feed that captures a content item shared by a participant. The candidate layout 806(3) includes two display areas where the display area on the left includes the video feed that captures the main presenter and the display area on the right includes a video feed that captures a participant that is responding to something said by the main presenter. The candidate layout 806(4) includes only one display area that contains a video feed that captures a participant that is responding to something said by the main presenter.

As illustrated, each candidate display area 806(1) through 806(N) captures at least part of the detected activity in a different layout (e.g., with regard to video feeds included in display area(s), number of display area(s), and/or positioning of video feeds within the display area(s)). The host or the producer can preview the different candidate display areas 806(1) through 806(N) to identify which one best captures the context of a communication session. The graphical user interface 800 of FIG. 8 is configured with control(s) that enable each of the candidate display areas 806(1) through 806(N) to be directly selected. As shown in this example, the host or the producer hovers a cursor 808 over candidate layout 806(3) or uses the cursor 808 to select the candidate layout 806(3). Based on this producer input, a control option (e.g., “go live” control option 810) to make the candidate layout the next layout to be displayed is presented. Upon selection of the “go live” control option 810, the candidate layout 806(3) is transitioned into the presentation area 804 and is broadcast live to the participants of the communication session (e.g., candidate layout 806(3) with two display areas replaces the current layout in the presentation area 804, which includes only one display area).

In various examples, an order in which the candidate layouts 806(1) through 806(N) are displayed is based on a ranking determined by the ranking algorithm. For instance, the ranking produced by the algorithm can provide that candidate layout 806(1) is the highest ranked candidate layout and can place the candidate layout 806(1) in a first recommended position (e.g., from left to right on the display screen). The ranking produced by the algorithm can provide that candidate layout 806(2) is the second highest ranked candidate layout and can place the candidate layout 806(2) in a second recommended position (e.g., from left to right on the display screen), and so forth.

In one example, the candidate layout staging area 802 can be configured to enable a host or a producer to scroll through a group of candidate layouts in a horizontal and/or vertical manner. This configuration can be useful in a situation where not all the candidate layouts can fit within the candidate layout staging area 802.

While FIG. 8 illustrates that the candidate layout staging area 802 is a display area below the presentation area 804, in alternative layouts, the candidate layout staging area 802 can be a display area above the presentation area 804 or side by side with the presentation area 804.

FIG. 9A illustrates another example graphical user interface 900 configured to display a view into a communication session for a host or a producer. The difference between FIG. 9A and FIG. 8 is that the example graphical user interface 900 includes a next layout staging area 902 (e.g., a “queue” area) which can be part of the general staging area used by a host or a producer to identify and select a next layout to be shared.

In one example, the candidate layout displayed in the next layout staging area 902 is automatically determined based on the ranking produced by the algorithm. That is, the algorithm provides that candidate layout 806(1) is the highest ranked candidate layout, and thus, the candidate layout 806(1) is placed in a first recommended position (e.g., from left to right on the display screen) and also is automatically displayed in the next layout staging area 902 so the host or the producer can preview the next layout and select a control option (e.g., “go live” control option 904) to make the candidate layout displayed in the next layout staging area 902 be displayed in the presentation area 804. That is, upon selection of the “go live” control option 904, the candidate layout 806(1) is transitioned into the presentation area 904 and is broadcast live to the participants of the communication session (e.g., candidate layout 806(1) with three display areas replaces the current layout in the presentation area 804, which includes only one display area).

FIG. 9B illustrates yet another example graphical user interface 906 configured to display a view into a communication session for a host or a producer. In this example, the candidate layout displayed in the next layout staging area 902 is determined based on user input. For instance, a host or a producer can use a cursor 908 to directly select candidate layout 806(3), and thus, the candidate layout 806(3) is moved from the candidate layout staging area 802 to the next layout staging area 902, where it is ready to be transitioned to the presentation area 804 based on selection of the “go live” control option 904.

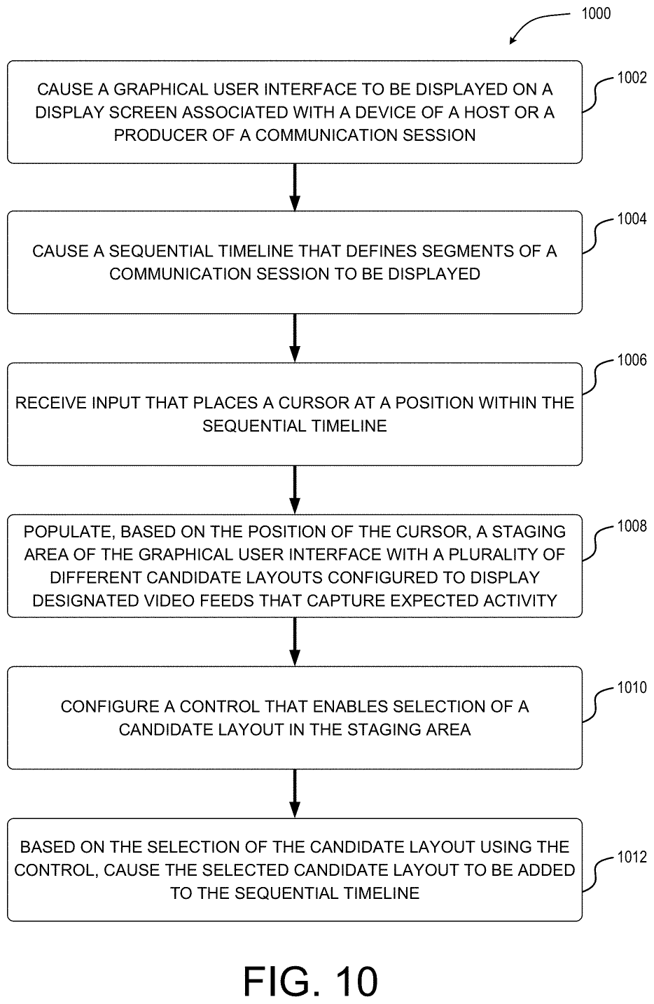

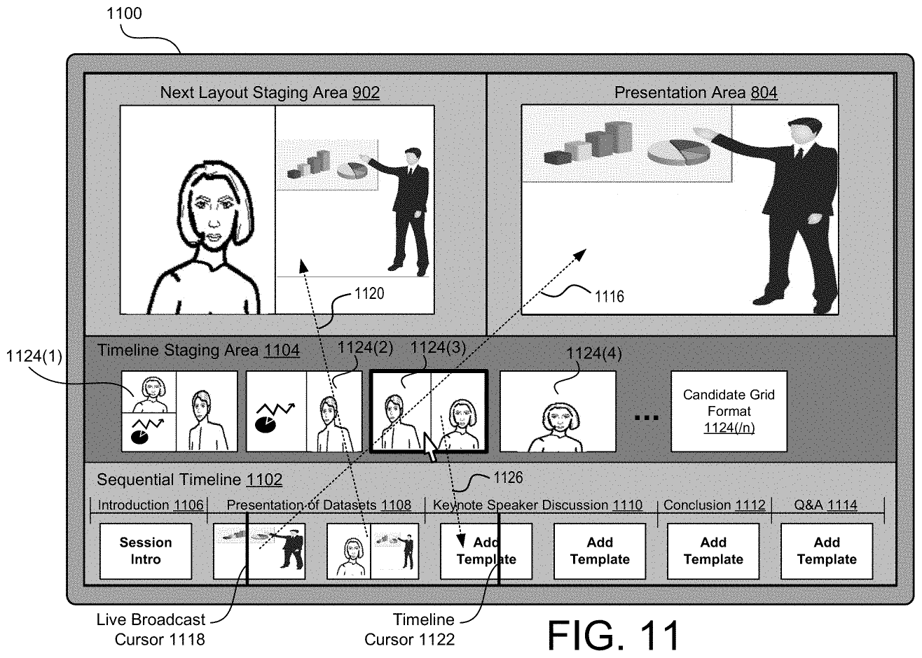

FIG. 10 is a diagram of an example flowchart 1000 that illustrates operations directed to enabling a host or a producer to add candidate layouts to a sequential timeline. The operations illustrated in FIG. 10 can be implemented in association with the example graphical user interface described herein with respect to FIG. 11. For instance, the various device(s) and/or module(s) in FIGS. 4 and/or 6 can generate, receive, transmit, and/or display data associated with content of a communication session (e.g., live content, recorded content, etc.) in order to compose the graphical user interface illustrated in FIG. 11.

At operation 1002, a graphical user interface is caused to be displayed on a display screen associated with a device of a host or a producer of a communication session.

At operation 1004, a sequential timeline that defines segments of a communication session is caused to be displayed in a portion of the graphical user interface. The segments can be identified based on an agenda for the communication session.

At operation 1006, input that places a cursor at a position within the sequential timeline is received.

At operation 1008, a staging area for the sequential timeline is populated with a plurality of different candidate layouts. The candidate layouts can be configured to display designated video feeds that capture expected activity based on the position of the cursor within the sequential timeline (e.g., the cursor being associated with a segment).

At operation 1010, a control that enables selection of a candidate layout in the staging area is configured. Examples of how a host or a producer can use various controls to select a candidate layout to be added to the sequential timeline is described herein with respect to FIG. 11.

At operation 1012, based on selection of the candidate layout using the control, a selected candidate layout is added to the sequential timeline.

As described above, after candidate layouts are added to the defined segments of the sequential timeline, the sequential timeline can be used to automatically implement the transitions from a current layout to a next layout.

FIG. 11 illustrates an example graphical user interface 1100 that illustrates how a candidate layout can be added to a sequential timeline 1102 displayed in a view provided to a host or a producer of a communication session. In this example, the view includes a timeline staging area 1104, as well as the presentation area 804 and next layout staging area 902 from FIGS. 9A and 9B. As described above, the presentation area 804 can include content of a communication session that is currently being shared (e.g., as part of a live broadcast) with the participants of a communication session. Alternatively, the presentation area 804 can include content of a rehearsal of a communication session. In FIG. 11, the current layout being shared in the presentation area 804 comprises a single video feed that captures a main presenter describing some charts, all of which is displayed in a single display area, for example.

The sequential timeline 1102 includes multiple segments, which can be identified based on an agenda for a communication session. For instance, the agenda can define information associated with each of the segments including the timing (e.g., a scheduled time period for each segment), scheduled speaker(s), content item(s) to be displayed, etc. As shown, the sequential timeline 1102 includes an introduction segment 1106, a presentation of datasets segment 1108, a keynote speaker discussion segment 1110, a conclusion segment 1112, and a question and answer (Q&A) segment 1114.

The current layout in the presentation area 804 corresponds to a candidate layout in the sequential timeline 1102 (as illustrated by the connecting arrow 1116), which is determined based on a position of a live broadcast cursor 1118 in the sequential timeline 1102. That is, as the communication session proceeds, the current layout that is displayed in the presentation area 804 and that is shared with the participants of the communication session can be based on a sequence of layouts added to the sequential timeline 1102 by the producer. To this end, the next layout to be displayed, as shown in the next layout staging area 902, corresponds to the layout that follows the current layout in the sequential timeline 1102 (as illustrated by the connecting arrow 1120).

To select and add a candidate layout to the sequential timeline 1102, the host or the producer can navigate a timeline cursor 1122 to a position on the sequential timeline 1102. Based on the position of the timeline cursor 1122, the staging module 628 populates the timeline staging area 1104 with a plurality of candidate layouts 1124(1) through 1124(N). The candidate layouts 1124(1) through 1124(N) can include designated video feeds that are likely to capture or contain activity (e.g., a participant) of an individual segment. For instance, a first designated video feed may be associated with a camera or other video capture device positioned to capture the first speaker, a second designated video feed may be associated with a camera or other video capture device positioned to capture a second speaker expected to interact with the first speaker, a third designated video feed may be associated with a camera or other video capture device positioned to capture a conference room in a remote office, a fourth designated video feed may be configured to display a content item (e.g., a slideshow) to be presented, and so forth.

Each of the candidate layouts 1124(1) through 1124(N) can be configured with a control that enables a user selection, and based on activation of the control, a candidate layout can be added to the sequential timeline 1102. As shown, a user can click on and/or drag candidate layout 1124(3) to the “template” placeholder in the keynote speaker discussion segment 1110 (as shown by the connecting arrow 1126).

The disclosure presented herein may be considered in view of the following clauses.

Example Clause A, a system comprising: one or more processing units; and a computer-readable medium having encoded thereon computer-executable instructions to cause the one or more processing units to: analyze a plurality of graphical items to identify characteristics associated with individual graphical items; access information defining preferred characteristics determined from previously selected graphical items; configure at least one layout, wherein an individual layout comprises a plurality of display areas, wherein individual display areas contain at least one graphical item of the plurality of graphical items, the at least one graphical item being selected based on a correspondence between the characteristics of the graphical item and the preferred characteristics; and populate a graphical user interface with the at least one layout.

Example Clause B, the system of Example Clause A, wherein the at least one layout comprises an arrangement of buttons on the graphical user interface.

Example Clause C, the system of Example Clause A, wherein an individual characteristic of a graphical item comprises functionality to be executed upon selection of the graphical item.

Example Clause D, the system of Example Clause A, wherein an individual characteristic of a graphical item comprises a specific type of data displayed via the graphical item.

Example Clause E, the system of Example Clause A, wherein an individual characteristic of a graphical item comprises a recognized type of object in the graphical item, an identification of a user in the graphical item, or a type of event captured in the graphical item, and the correspondence between the characteristics of the graphical item and the preferred characteristics is based on a matching characteristic.

Example Clause F, the system of Example Clause A, wherein the plurality of graphical items comprises a plurality of video feeds being input to a communication session and the at least one layout comprises a plurality of layouts, the computer-executable instructions further causing the one or more processing units to: configure a control that enables a selection of one of the plurality of layouts; and based on the selection of the one of the plurality of layouts using the control, cause the one of the plurality of layouts to be displayed in the communication session.

Example Clause G, the system of Example Clause F, wherein the previous selected graphical items are selected by a same user that makes the selection of the one of the plurality of layouts using the control.

Example Clause H, the system of Example Clause F or Example Clause G, wherein the one of the plurality of layouts is displayed in a portion of the graphical user interface configured to preview a next layout to be displayed in the communication session.

Example Clause I, the system of one of Example Clauses F through H, wherein an individual characteristic comprises at least one of a participant speaking, a participant moving, or a file being shared.

Example Clause J, the system of Example Clause A, wherein the plurality of graphical items comprises a plurality of photos.

Example Clause K, the system of one of Example Clauses A through J, wherein the at least one layout comprises a plurality of layouts and the information further includes preferred layouts of graphical items determined from previously selected layouts, the computer-executable instructions further causing the one or more processing units to generate an algorithm useable to rank the plurality of layouts based at least in part on the information, wherein the algorithm comprises a parameter that prioritizes at least one of: a number of display areas in an individual layout, a size of a display area in an individual layout, or a position of a display area that contains a particular graphical item in an individual layout.

Example Clause L, a method comprising: analyzing a plurality of graphical items to identify characteristics of each graphical item; accessing, by one or more processing units, information that includes preferred characteristics of graphical items, the preferred characteristics determined from previously selected graphical items; configuring a plurality of layouts, wherein an individual layout comprises a plurality of display areas, wherein individual display areas contain at least one graphical item of the plurality of graphical items, the at least one graphical item being selected based on a correspondence between the characteristics of the graphical item and the preferred characteristics; and populating a graphical user interface with the plurality of layouts.

Example Clause M, the method of Example Clause L, wherein an individual characteristic of a graphical item comprises a recognized type of object in the graphical item, an identification of a user in the graphical item, or a type of event captured in the graphical item, and the correspondence between the characteristics of the graphical item and the preferred characteristics is based on a matching characteristic.

Example Clause N, the method of Example Clause L, further comprising: configuring a control that enables a selection of one of the plurality of layouts; and based on the selection of the one of the plurality of layouts using the control, causing the one of the plurality of layouts to be displayed in a communication session.

Example Clause O, the method of Example Clause N, wherein an individual characteristic comprises at least one of a participant speaking, a participant moving, or a file being shared.

Example Clause P, the method of any one of Example Clauses L through O, wherein the plurality of layouts differ in at least one of: a number of display areas, a size of a display area, or a position of a display area that contains a particular graphical item.

Example Clause Q, a system comprising: means to analyze a plurality of graphical items to identify characteristics of each graphical item; means to access information that includes preferred characteristics, the preferred characteristics determined from previously selected graphical items; means to configure at least one layout, wherein an individual layout comprises a plurality of display areas, wherein individual display areas contain at least one graphical item of the plurality of graphical items, the at least one graphical item being selected based on a correspondence between the characteristics of the graphical item and the preferred characteristics; and means to display the at least one layout within a graphical user interface.

Example Clause R, the system of Example Clause Q, wherein an individual characteristic of a graphical item comprises a recognized type of object in the graphical item, an identification of a user in the graphical item, or a type of event captured in the graphical item, and the correspondence between the characteristics of the graphical item and the preferred characteristics is based on a matching characteristic.

Example Clause S, the system of Example Clause Q or Example Clause R, wherein the at least one layout comprises a plurality of layouts and the information further includes preferred layouts of graphical items determined from previously selected layouts, the system further comprising means to generate an algorithm useable to rank the plurality of layouts based at least in part on the information.

Example Clause T, the system of Example Clause S, wherein the algorithm comprises a parameter that prioritizes at least one of: a number of display areas in an individual layout, a size of a display area in an individual layout, or a position of a display area that contains a particular graphical item in an individual layout.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A system comprising:
one or more processing units; and
a computer-readable medium having encoded thereon computer-executable instructions to cause the one or more processing units to:
analyze a plurality of video feeds being input to a communication session to identify characteristics associated with individual video feeds;
access information defining preferred characteristics determined from previously selected video feeds;
configure a plurality of layouts, wherein an individual layout comprises a plurality of display areas, wherein individual display areas contain a video feed of the plurality of video feeds and the video feed is selected based on a correspondence between the characteristics of the video feed and the preferred characteristics;
populate a graphical user interface with the plurality of layouts;
configure a control that enables a selection of one of the plurality of layouts; and
based on the selection of the one of the plurality of layouts using the control, cause the one of the plurality of layouts to be displayed in the communication session.

2-4. (canceled)

5. The system of claim 1, wherein an individual characteristic of a video feed comprises a recognized type of object in the video feed, an identification of a user in the video feed, or a type of event captured in the video feed, and the correspondence between the characteristics of the video feed and the preferred characteristics is based on a matching characteristic.

6. (canceled)

7. The system of claim 1, wherein the previous selected video feeds are selected by a same user that makes the selection of the one of the plurality of layouts using the control.

8. The system of claim 1, wherein the one of the plurality of layouts is displayed in a portion of the graphical user interface configured to preview a next layout to be displayed in the communication session.

9. The system of claim 1, wherein an individual characteristic comprises at least one of a participant speaking, a participant moving, or a file being shared.

10. (canceled)

11. The system of claim 1, wherein the information further includes preferred layouts of video feeds determined from previously selected layouts, the computer-executable instructions further causing the one or more processing units to generate an algorithm useable to rank the plurality of layouts based at least in part on the information, wherein the algorithm comprises a parameter that prioritizes at least one of: a number of display areas in an individual layout, a size of a display area in an individual layout, or a position of a display area that contains a particular video feed in an individual layout.

12. A method comprising:
analyzing a plurality of video feeds being input to a communication session to identify characteristics of each video feed;
accessing, by one or more processing units, information that includes preferred characteristics of video feeds, the preferred characteristics determined from previously selected video feeds;
configuring a plurality of layouts, wherein an individual layout comprises a plurality of display areas, wherein individual display areas contain a video feed of the plurality of video feeds and the video feed is selected based on a correspondence between the characteristics of the video feed and the preferred characteristics;
populating a graphical user interface with the plurality of layouts;
configuring a control that enables a selection of one of the plurality of layouts; and
based on the selection of the one of the plurality of layouts using the control, cause the one of the plurality of layouts to be displayed in the communication session.

13. The method of claim 12, wherein an individual characteristic of a video feed comprises a recognized type of object in the video feed, an identification of a user in the video feed, or a type of event captured in the video feed, and the correspondence between the characteristics of the video feed and the preferred characteristics is based on a matching characteristic.

14. (canceled)

15. The method of claim 12, wherein an individual characteristic comprises at least one of a participant speaking, a participant moving, or a file being shared.

16. The method of claim 12, wherein the plurality of layouts differ in at least one of: a number of display areas, a size of a display area, or a position of a display area that contains a particular video feed.

17. A system comprising:
means to analyze a plurality of video feeds being input to a communication session to identify characteristics of each video feed graphical item;
means to access information that includes preferred characteristics, the preferred characteristics determined from previously selected video feeds;
means to configure a plurality of layouts, wherein an individual layout comprises a plurality of display areas, wherein individual display areas contain a video feed of the plurality of, video feeds and the video feed is selected based on a correspondence between the characteristics of the video feed and the preferred characteristics;
means to display the plurality of layouts within a graphical user interface;
means to configure a control that enables a selection of one of the plurality of layouts; and
based on the selection of the one of the plurality of layouts using the control, means to cause the one of the plurality of layouts to be displayed in the communication session.

18. The system of claim 17, wherein an individual characteristic of a video feed comprises a recognized type of object in the video feed, an identification of a user in the video feed, or a type of event captured in the video feed, and the correspondence between the characteristics of the video feed and the preferred characteristics is based on a matching characteristic.

19. The system of claim 17, wherein the information further includes preferred layouts of video feeds determined from previously selected layouts, the system further comprising means to generate an algorithm useable to rank the plurality of layouts based at least in part on the information.

20. The system of claim 19, wherein the algorithm comprises a parameter that prioritizes at least one of: a number of display areas in an individual layout, a size of a display area in an individual layout, or a position of a display area that contains a particular graphical item in an individual layout.

21. The method of claim 12, wherein the previous selected video feeds are selected by a same user that makes the selection of the one of the plurality of layouts using the control.

22. The method of claim 12, wherein the one of the plurality of layouts is displayed in a portion of the graphical user interface configured to preview a next layout to be displayed in the communication session.

23. The method of claim 12, wherein the information further includes preferred layouts of video feeds determined from previously selected layouts, the method further comprising generating an algorithm useable to rank the plurality of layouts based at least in part on the information, wherein the algorithm comprises a parameter that prioritizes at least one of: a number of display areas in an individual layout, a size of a display area in an individual layout, or a position of a display area that contains a particular video feed in an individual layout.

24. The system of claim 17, wherein the previous selected video feeds are selected by a same user that makes the selection of the one of the plurality of layouts using the control.

25. The system of claim 17, wherein the one of the plurality of layouts is displayed in a portion of the graphical user interface configured to preview a next layout to be displayed in the communication session.

26. The system of claim 17, wherein an individual characteristic comprises at least one of a participant speaking, a participant moving, or a file being shared.
